(19) United States
(12) Patent Application Publication
(10) Pub. No.: US 2023/0297915 A1
(43) Pub. Date: Sep. 21, 2023

(54) TIME-CONSISTENT RISK-SENSITIVE DECISION-MAKING WITH PROBABILISTIC DISCOUNT

(71) Applicant: International Business Machines Corporation, Armonk, NY (US)

(72) Inventor: Takayuki Osogami, Yamato-shi (JP)

(21) Appl. No.: 17/655,040

(22) Filed: Mar. 16, 2022

(51) Int. Cl. G06Q 10/06; G06N 7/00

(52) U.S. Cl. CPC G06Q 10/0635; G06N 7/005

(57) ABSTRACT

A computer implemented method determines a policy for risk sensitive decisions. A computer system receives state and action pairs. The computer system, with initial probabilistic discounted entropic risk measure values for the state and action pairs, determines in a recursive manner current probabilistic discounted entropic risk measure values for the state and action pairs based on a risk factor until the current probabilistic discounted entropic risk measure values reach a desired level. The current probabilistic discounted entropic risk measure values are the initial probabilistic discounted entropic risk measure values for a next determination. The computer system selects a set of the state and action pairs for the policy using the current probabilistic discounted entropic risk measure values present in response to the probabilistic discounted entropic risk measure values, wherein a system operates using the policy

### BACKGROUND

### 1. Field

The disclosure relates generally to an improved computer system and more specifically to a method, apparatus, computer system, and computer program product for decision-making.

### 2. Description of the Related Art

Decision-making is involved in many processes. Decision-making to select actions to reach a goal can be used in areas such as robotic automation, autopiloting, manufacturing plant control, inventory control, and other areas. For example, with robot control, decision-making is involved in selecting actions to move a robot from point A to point B along a path. This decision-making can take into account parameters such as hazards, obstacles, speed, and other parameters. Manufacturing plant control, decision-making can be made to control parameters such as temperature and pressure in in the plants when manufacturing products. Inventory control can include decisions to perform actions with respect to placing orders, moving inventory to different locations, and other actions. The decisions on what actions performed for inventor control can be based on parameters such as expected demand, shelf life, hoarding, and other parameters.

A policy of sequential decision-making can be made by taking risk into account rather than maximizing the standard expected return. A policy defines what actions should be chosen for a particular observed state. In other words, policy maps a state to an action.

In decision-making using a policy, future rewards are often less desirable than immediate rewards. As a result, discounting of rewards can be performed. For example, the reward Rₙ can be geometrically discounted in n steps by γⁿRₙ for 0<γ<1, wherein γ is the discount rate. With a geometric discount, some properties include an ability to compute an optimal policy in polynomial time with dynamic programming, and the optimal policy is optimal in the future. In other words, the policy can be time-consistent in which the expectation is time-consistent with the geometric discount.

### SUMMARY

According to one illustrative embodiment, a computer implemented method determines a policy for risk sensitive decisions. A computer system receives state and action pairs. The computer system, with initial probabilistic discounted entropic risk measure values for the state and action pairs, determines in a recursive manner current probabilistic discounted entropic risk measure values for the state and action pairs based on a risk factor until the current probabilistic discounted entropic risk measure values reach a desired level. The current probabilistic discounted entropic risk measure values are the initial probabilistic discounted entropic risk measure values for a next determination. The computer system selects a set of the state and action pairs for the policy using the current probabilistic discounted entropic risk measure values present in response to the current probabilistic discounted entropic risk measure values reaching the desired level. A system operates using the policy. According to other illustrative embodiments, a computer system and a computer program product for determining a policy for risk sensitive decisions are provided.

### BRIEF DESCRIPTION OF THE DRAWINGS

FIG. 1 is a pictorial representation of a network of data processing systems in which illustrative embodiments may be implemented;

FIG. 2 is a block diagram of a policy environment in accordance with an illustrative embodiment;

FIG. 3 is an illustration of decision-making for a robot moving along a cliff in accordance with an illustrative embodiment;

FIG. 4 is an illustration of scores for a robot traveling from a start point to an end point with respect to a cliff zone in accordance with an illustrative embodiment;

FIG. 5 is a flowchart of a process for generating a policy for risk sensitive decision-making in accordance with an illustrative embodiment;

FIG. 6 is a flowchart of a process for determining a policy for risk sensitive decision-making in accordance with an illustrative embodiment;

FIG. 7 is a flowchart of a process for determining current probabilistic discounted entropic risk measure values for the state and action pairs based on a risk factor in a recursive manner in accordance with an illustrative embodiment; and

FIG. 8 is a block diagram of a data processing system in accordance with an illustrative embodiment.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The illustrative embodiments recognize and take into account a number of different considerations as described below. For example, the illustrative embodiments recognize and take into account that it would be desirable to have a policy with sequential decision-making by taking risk into account rather than maximizing a standard expected return. The illustrative embodiments recognize and take into account that future rewards are less desirable than immediate rewards. Geometric discounting can be performed by maximizing expectation. This type of discounting does not work well when the discount is not geometric or the objective is not an expectation. For example, the discount could be hyperbolic. As another example, the expectation can be an entropic risk measure.

Thus, with recognizing and taking into account these and other considerations, one or more illustrative examples can take into account a probabilistic discount. A probabilistic discount of a return that is a cumulative reward can be as follows: R′=R₀ with probability 1−γ; R₀+R₁ with probability γ (1−γ); R₀+R₁30 R₂ with probability γ²(1−γ) . . . where γ is the discount rate. A probabilistic discount is also referred to as a p-discount.

This type of discount can enable dynamic programming for risks sensitive sequential decision-making. In an illustrative example, a policy for risks sensitive decision can be determined with the initial probabilistic discounted entropic risk measure values for the state and action pairs, in a recursive manner by determining current probabilistic discounted entropic risk measure values for the state and action pairs based on a risk factor until the current probabilistic discounted entropic risk measure values reach a desired level. The current probabilistic discounted entropic risk measure values are intermediate values that become the initial probabilistic discounted entropic risk measure values for a next determination.

In the illustrative levels, this desired level can be reached in a number of different ways. For example, these iterations can be performed until some threshold is met. The threshold can be a number of iterations, changes in the current probabilistic discounted entropic risk measure values that are less than a threshold, or some other metric. A set of the state and action pairs for the policy are selected using the current probabilistic discounted entropic risk measure values present in response to the probabilistic discounted entropic risk measure values reaching the desired level for the values.

Thus, illustrative embodiments recognize and take into account the different considerations described above and provide a computer implemented method, computer system, and computer program product for determining a policy for risk sensitive decisions. A computer system receives state and action pairs. The computer system, with initial probabilistic discounted entropic risk measure values for the state and action pairs, determines in a recursive manner current probabilistic discounted entropic risk measure values for the state and action pairs based on a risk factor until the current probabilistic discounted entropic risk measure values reach a desired level. The current probabilistic discounted entropic risk measure values are the initial probabilistic discounted entropic risk measure values for a next determination. The computer system selects a set of the state and action pairs for the policy using the current probabilistic discounted entropic risk measure values present in response to the probabilistic discounted entropic risk measure values, wherein a system operates using the policy.

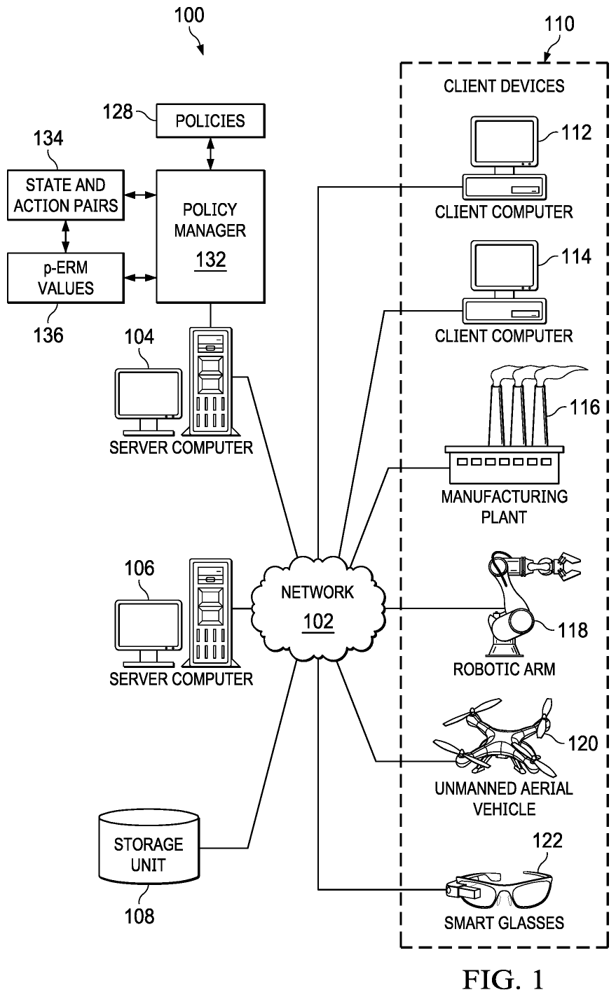

With reference now to the figures and, in particular, with reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112 and client computer 114. Client devices 110 can be, for example, computers, workstations, or network computers. In the depicted example, server computer 104 provides information, such as boot files, operating system images, and applications to client devices 110. Further, client devices 110 can also include other types of client devices such as manufacturing plant 116, robotic arm 118, unmanned aerial vehicle (UAV) 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program instructions located in network data processing system 100 can be stored on a computer-recordable storage media and downloaded to a data processing system or other device for use. For example, program instructions can be stored on a computer-recordable storage media on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). FIG. 1 is intended as an example, and not as an architectural limitation for the different illustrative embodiments.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

As depicted, policies 128 can be used by client devices 110 such as manufacturing plant 116, robotic arm 118, and unmanned aerial vehicle 120 to make decisions on what actions to perform. Policies 128 can be used for sequential decision-making by these client devices in which actions are selected based on states.

In this illustrative example, policies 128 can be created and improved upon by policy manager 132, located in server computer 104. In this illustrative example, policy manager 132 can identify the policies 128 for manufacturing plant 116, robotic arm 118, and unmanned aerial vehicle 120 to perform risk sensitive decision-making. These policies can be identified from state and action pairs 134. States in state and action pairs 134 are sequential states in this example.

In this illustrative example, the current probabilistic entropic risk measure (p-ERM) can be calculated for the current state and action pair using a subsequent probabilistic discounted entropic risk measure (p-ERM) calculated for a subsequent state and action pair. The previous state and action pair is a previous state that led to the current state by performing the action of the previous state. In this illustrative example, probabilistic discounted entropic risk measure (p-ERM) is entropic risk measure of the cumulative of rewards with a probabilistic discount.

These calculations are recursively performed by policy manager 132 for state and action pairs 134 to obtain probabilistic discounted entropic risk measure (p-ERM) values 136. Selected state and action pairs are chosen from state and action pairs 134 based on probabilistic discounted entropic risk measure (p-ERM) values 136 for state and action pairs to form policies 128 for manufacturing plant 116, robotic arm 118, and unmanned aerial vehicle 120 in these examples. These policies can be sent over network 102 for manufacturing plant 116, robotic arm 118, and unmanned aerial vehicle 120. These client devices can be used to perform sequential decision-making.

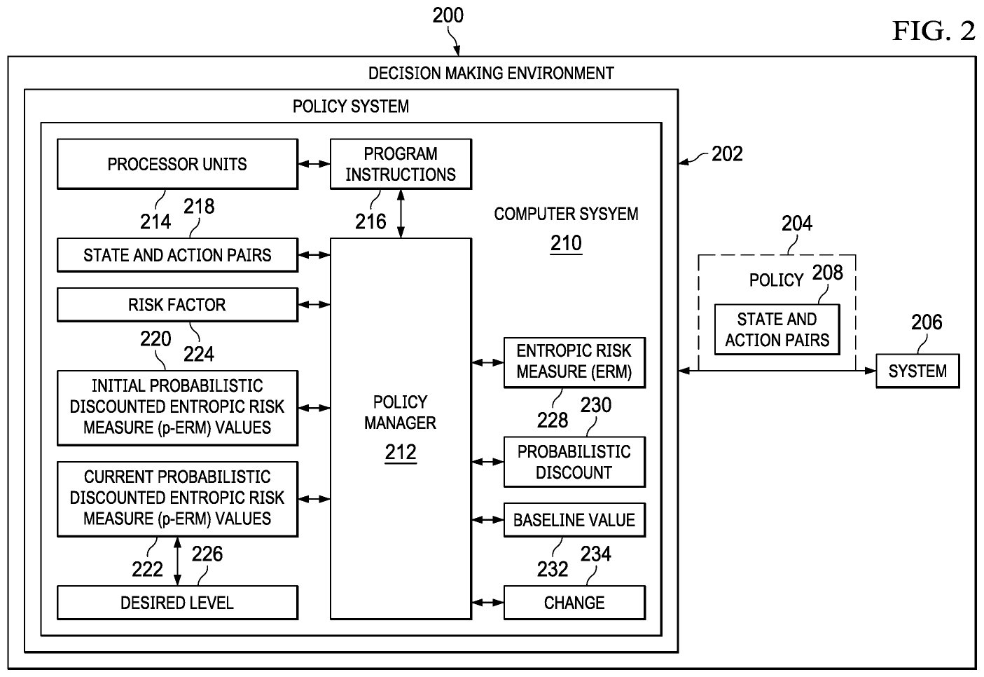

With reference now to FIG. 2, a block diagram of decision-making policy environment is depicted in accordance with an illustrative embodiment. In this illustrative example, decision-making environment 200 includes components that can be implemented in hardware such as the hardware shown in network data processing system 100 in FIG. 1.

In this illustrative example, policy system 202 can generate policy 204 for use by system 206 to perform decision-making. In this illustrative example, policy 204 comprises state and action pairs 208. Each state and action pair in state and action pairs 208 comprises a state and an action that can be performed in the state. Policy 204 can be used for sequential decision-making this example in which transitions occur from one state to another state through the performance of actions.

For example, the performance of an action a in a current state s in state and action pairs 208 can result in a transition into a next state s′ in state and action pairs 208. In this example, a current state s in a state and action pair is a state in a process and the action a in the state action and pair is an action that can be performed for that state. Performance of the action a results in a transition from the current state s to the next state s′ providing a corresponding reward which can be referred to as r(s, a, s′).

In this example, for a given state and a given action, the transition is independent of previous states and satisfies a Markov property as part of a Markov decision process. Different rewards can result from performing different actions in different states.

In the illustrative example, the process can be, for example, moving a robot. With this example, the state can be, for example, a position of a robot. An action moving the robot in a particular direction causes the robot to transition or move into another state represented by the new position of the robot. As another example, the state can be a particular state of a process. An action can be to change the temperature for the process, add a component to the process, or other action that causes the state to transition into another state. In this manner, state and action pairs 208 can be used to operate system 206 being at a starting state and reach an ending or goal state in state and action pairs 208.

In this illustrative example, system 206 can be a hardware system, a software system, or a combination of the two. For example, system 206 can be one of a robot, a robotic arm, a self-driving vehicle, a manufacturing plant, a financial trading system, an inventory control system, a semiconductor wafer processing system, and other suitable types of systems that can use a policy to operate. For example, state and action pairs 208 and policy 204 can be used by a robot in a manufacturing facility to move from a beginning location to an ending location. The beginning location can be represented by one state in state and action pairs 208 and the ending location can be represented by another state in state and action pairs 208. A robot can perform actions to sequentially transition from one state to another state to move the robot from the beginning location to the ending location.

As depicted, policy system 202 comprises computer system 210 and policy manager 212. Policy manager 212 can be implemented in software, hardware, firmware or a combination thereof. When software is used, the operations performed by policy manager 212 can be implemented in program instructions configured to run on hardware, such as a processor unit. When firmware is used, the operations performed by policy manager 212 can be implemented in program instructions and data and stored in persistent memory to run on a processor unit. When hardware is employed, the hardware can include circuits that operate to perform the operations in policy manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 210 is a physical hardware system and includes one or more data processing systems. When more than one data processing system is present in computer system 210, those data processing systems are in communication with each other using a communications medium. The communications medium can be a network. The data processing systems can be selected from at least one of a computer, a server computer, a tablet computer, or some other suitable data processing system.

As depicted, computer system 210 includes a number of processor units 214 that are capable of executing program instructions 216 implementing processes in the illustrative examples. As used herein a processor unit in the number of processor units 214 is a hardware device and is comprised of hardware circuits such as those on an integrated circuit that respond and process instructions and program code that operate a computer. When a number of processor units 214 execute program instructions 216 for a process, the number of processor units 214 is one or more processor units that can be on the same computer or on different computers. In other words, the process can be distributed between processor units on the same or different computers in a computer system. Further, the number of processor units 214 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

In the illustrative example, policy manager 212 can determine policy 204 in a manner that takes into account risk. For example, policy manager 212 can determine policy 204 for risk sensitive decision-making.

As depicted, policy manager 212 receives state and action pairs 218. In the example, state and action pairs 208 in policy 204 are a subset of state and action pairs 218. In other words, state and action pairs 218 can include states and associated actions that are not found in policy 204.

Policy manager 212 begins by determining policy 204 using initial probabilistic discounted entropic risk measure (p-ERM) values 220 for state and action pairs 218. In this illustrative example, policy manager 212 determines in a recursive manner current probabilistic discounted entropic risk measure (p-ERM) values 222 for state and action pairs 218 based on risk factor 224 until current probabilistic discounted entropic risk measure (p-ERM) values 222 reach a desired level 226. Current probabilistic discounted entropic risk measure (p-ERM) values 222 are initial probabilistic discounted entropic risk measure (p-ERM) values for a next determination.

In this illustrative example, using initial probabilistic discounted entropic risk measure (p-ERM) values 220, determinations can be made for current probabilistic discounted entropic risk measure (p-ERM) values 222 until current probabilistic discounted entropic risk measure (p-ERM) values 222 meet a desired level. Current probabilistic discounted entropic risk measure (p-ERM) values 222 are values for entropic risk measure (ERM) 228 in which these values for entropic risk measure (ERM) 228 are discounted. Entropic risk measure (ERM) 228 is a risk measure though risk factor 224 using exponential utility function as follows:

$${ERM}_{α} [ X ] = \frac{1}{α} log E [ {e}^{α X} ] \qquad ( 1 )$$

where α is risk factor 224 and X is the immediate reward. The immediate reward X can be r(s,a,s′) in which r is the immediate reward for taking action a at a current state s to advance to the next state s′. Risk factor 224 is measure of aversion to risk by system 206. In this example, the discounting is probabilistic discount 230, which is also referred to as a p-discount.

In this example, probabilistic discounted entropic risk measure (p-ERM) values can be determined as follows:

$$\begin{matrix}{V}_{N + 1} ( s ) & = & {max}_{α ∈} \frac{1}{α} log p ( {s}^{′} \vert s , a ) {e}^{αr ( s , a , {s}^{′} )} ( ( 1 - γ ) + γ {e}^{α {V}_{N} ( {s}^{′} )} ) & ( 2 ) \\ & = & {max}_{α ∈} {Q}_{N + 1} ( s , a ) & ( 3 )\end{matrix}$$

where α is risk factor 224, for s∈ [symbol] , where [symbol] is the state space, [symbol] is the action space, p(s′|s, a) is the transition probability to the next state s′ when taking action a at the current state s, and r(s, a, s′) is the reward associated with that transition.

Policy manager 212 selects a set of state and action pairs 218 that form policy 204. The set of state and action pairs 218 can be selected using current probabilistic discounted entropic risk measure (p-ERM) values present in response to the probabilistic discounted entropic risk measure values reaching desired level 226. In this depicted example, the set of state and action pairs 218 form state and action pairs 208 in policy 204.

This illustrative example, policy manager 212 sends policy 204 to system 206. System 206 can operate making decisions using the policy 204. For example, system 206 can move from point A to point B using policy 204. In another illustrative example, system 206 can control inventory levels using policy 204. These and other types of operations can be performed depending on system 206 and policy 204.

Policy manager 212 can recursively determine probabilistic entropic risk measure values in a number of different ways. For example, policy manager 212 can set initial probabilistic discounted entropic risk measure (p-ERM) values 220 for state and action pairs 218 using baseline value 232. Policy manager 212 determines change 234 from baseline value 232 for initial probabilistic discounted entropic risk measure (p-ERM) values 220.

Policy manager 212 updates current initial probabilistic discounted entropic risk measure (p-ERM) values 220 for state and action pairs 208 using change 234 from baseline value 232. Policy manager 212 updates baseline value 232 with change 234. In this example, this update is made by adding change 234 to baseline value 232. The updated baseline value becomes baseline value 232 for additional calculations in this recursive process.

Policy manager 212 determines whether the updates to current initial probabilistic discounted entropic risk measure (p-ERM) values 220 are complete. If the updates are not complete, policy manager 212 repeats determining change 234, determining current discounted entropic risk measure (p-ERM) values 222, and updating baseline value 232.

For computational purposes to avoid overflows and complications, the probabilistic discounted entropic risk measure values can be normalized. The normalization can be the undone after the updating has been completed.

Computer system 210 can be configured to perform at least one of the steps, operations, or actions described in the different illustrative examples using software, hardware, firmware or a combination thereof. As a result, computer system 210 operates as a special purpose computer system in which policy manager 212 in computer system 210 enables determining policies based on an entropic risk measure of the expectation of rewards with a probabilistic discount.

The illustration of decision-making environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, one or more systems in addition the system 206 can be present in decision-making environment 200. In yet another illustrative example, policy manager 212 can generate multiple policies for use by system 206. In this example, the different policies can be used for different situations or different environments in which system 206 may operate.

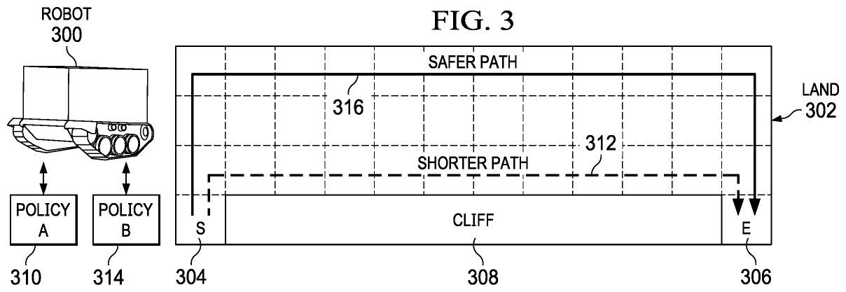

Turning next to FIG. 3, an illustration of decision-making for a robot moving along a cliff in accordance with an illustrative embodiment. In this illustrative example, robot 300 operates on land 302. In this example, each square depicted on land 302 represents a position on land 302. Robot 300 moves from start position 304 to end position 306. The goal is to reach end position 306 while avoiding falling off cliff 308.

The movement of robot 300 from start position 304 to end position 306 can be performed using a policy and action pairs, such as policy 204 generated by policy manager 212 in FIG. 2. For example, robot 300 using policy A 310 moves along path 312 from start position to end position 306. Robot 300 using policy B 314 moves along path 316 from start position 304 to end position 306. These policies comprise state and action pairs in which the state is a position on land 302 and the action is a movement a direction from the position.

In this example, each of these policies are generated based on a risk factor for movement of robot 300 with respect to cliff 308. For example, policy A 310 has risk factor that is greater than zero while policy B 314 the risk factor that is less than zero.

As depicted in this example, policy A 310 results in robot 300 moving from start position 304 to end position 306 more quickly and by a shorter distance along path 312. However, the probability of robot 300 falling off cliff 308 is greater than if robot 300 uses policy B 314 and travels along path 316. Path 316 has a lower likelihood of falling off cliff 308. However, path 316 is a longer path that takes more time to reach end position 306.

Illustration of movement of robot 300 is provided as an example and not meant to limit the manner in which other policies may be used. For example, a policy may be determined for operating a manufacturing facility in which the states can be different states for manufacturing of a product. The actions can be actions such as selecting a temperature, pressure, component, or other action with respect to manufacturing the product. In yet another illustrative example, the policy can be determined for operating a self-driving vehicle, unmanned aerial vehicle performing a survey, or other suitable types of operations for other types of vehicles.

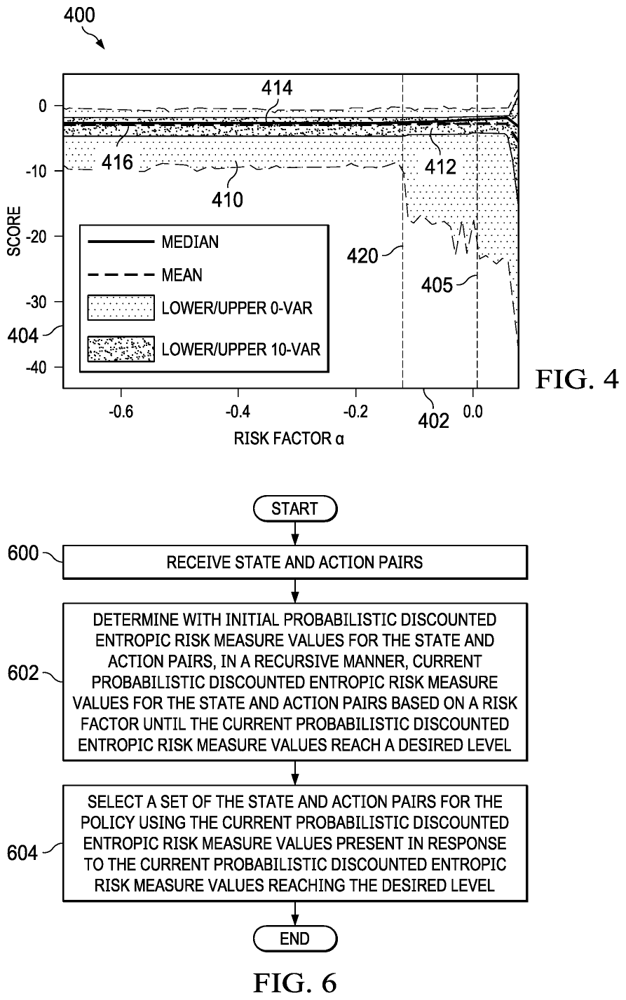

With reference to FIG. 4, an illustration of scores for a robot traveling from a start point to an end point with respect to a cliff zone is depicted in accordance with an illustrative embodiment. As depicted in graph 400, x-axis 402 represents a risk factor α, and y-axis 404 represents a score. The score is a reward and higher scores are more desirable in this depicted example.

The score can represent the amount of time it takes robot 300 in FIG. 3 to travel from start position 304 to end position 306 and whether robot 300 falls of cliff 308. The amount of time is reduced as a score increases. The score also takes into account as to whether robot 300 falls off cliff 308. The amount of time increases as the score decreases. Further, as the score decreases the probability of falling off cliff 308 also increases.

As depicted, line 405 represents a risk factor of zero, which is risk neutral. In this example, both lower/upper 0 value at risk (VaR) in section 410 and lower/upper 10 value at risk (VaR) in section 412 indicates that as the risk factor increases, the score can be higher but a greater risk is present in a lower score indicating falling off cliff 308 when moving from start position 304 to end position 306. Median scores are shown by line 414 and mean scores are shown by line 416.

With a risk factor that is less than zero, the possibility falling off cliff 308 reduces as a risk factor becomes more negative. For example, with a risk factor of less than −0.125 at line 420, the probability of falling off cliff 308 is no longer present in this example. However, the potential high value for the score is lower than when the risk factor is greater than zero. In this illustrative example, policy A 310 and policy B 314 are determined taking into account these risk factors and the potential scores. Thus, policies can be generated for systems that take into account the risk factors using a probabilistic discounted entropic risk measure analysis to determine which state and action pairs should be included in the policy.

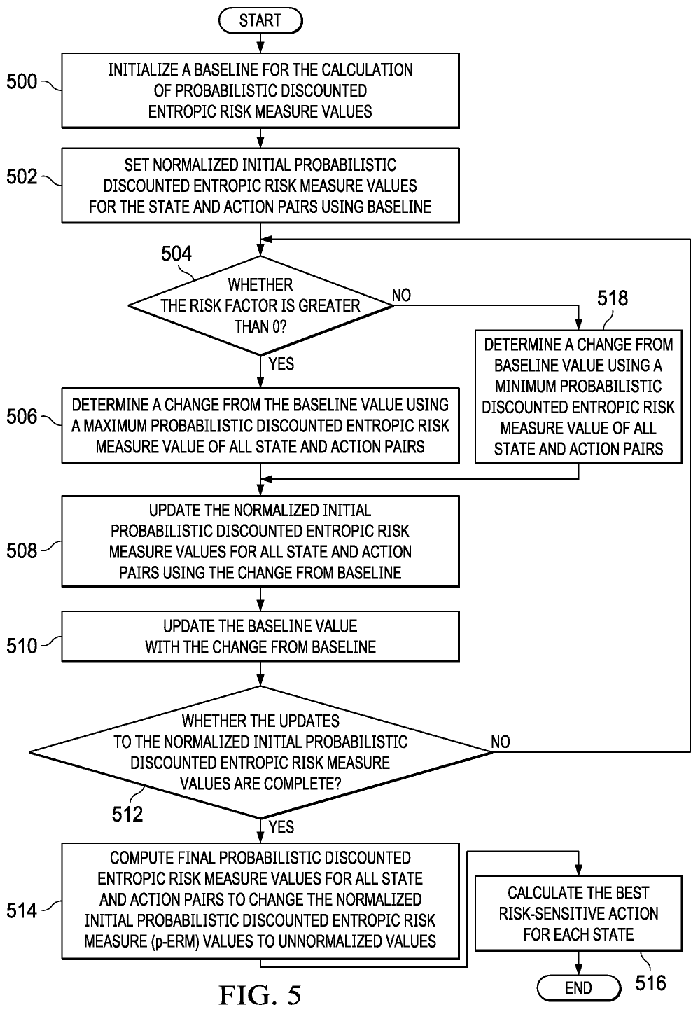

Turning next to FIG. 5, a flowchart of a process for generating a policy for risk sensitive decision-making is depicted in accordance with an illustrative embodiment. The process in FIG. 5 can be implemented in hardware, software, or both. When implemented in software, the process can take the form of program code that is run by one of more processor units located in one or more hardware devices in one or more computer systems. For example, the process can be implemented in policy manager 212 in computer system 210 in FIG. 2.

The process begins by initializing a baseline B for the calculation of probabilistic discounted entropic risk measure (p-ERM) values (step 500). In this illustrative example, the baseline B is a single value that represents a maximum probabilistic discounted entropic risk measure (p-ERM) value of all state and action pairs. Each state and action pair include a state and an action that can be potentially taken at that state.

In this illustrative example, an immediate reward is returned by taking an action at a state and the probabilistic discounted entropic risk measure (p-ERM) value represents the cumulative reward that is returned by taking a course of actions at states, where the reward is probabilistically discounted and the cumulative reward is adjusted in consideration of risk. In step 500, the baseline B can be set to 0 for the purpose of initialization to avoid arithmetic overflow.

The process sets normalized initial probabilistic discounted entropic risk measure (p-ERM) values for all state and action pairs using baseline B (step 502). In this illustrative example, a normalized initial probabilistic discounted entropic risk measure (p-ERM) value is associated with each state-action pair. In this example, the baseline B and the initial probabilistic discounted entropic risk measure (p-ERM) values for all state and action pairs can be used to generate a policy for decision-making that identifies the actions that return the highest cumulative reward that can be obtained at each state when a risk factor is included in the decision-making.

In step 502, the normalized initial probabilistic discounted entropic risk measure (p-ERM) values for all state and action pairs are normalized values and expressed using a function of U(s, a) as follows:

U(s, a)=1, ∀(s, a)∈ [symbol] × [symbol] (4)

where s is a state of state space [symbol] , a is an action of action space [symbol] . In this illustrative example, function U(s, a) is a representation of a cumulative reward that is returned by taking action a at state s when the risk factor is included in the calculations. In this illustrative example, the cumulative rewards return by the function U(s, a) includes the immediate rewards returned by taking action a at state s and all rewards from taking actions at subsequent states. With U(s,a) representing a normalized probabilistic discounted entropic risk measure, U(s,a) is a cumulative reward with risk taken into account. The state space [symbol] is a set of all the states that can be transitioned to, and the action space [symbol] is a set of all actions that can be performed at each state.

In this illustrative example, the normalized initial probabilistic discounted entropic risk measure (p-ERM) values for all state and action pairs can be an example of current probabilistic discounted entropic risk measure (p-ERM) values 222 in FIG. 2. The normalized initial probabilistic discounted entropic risk measure (p-ERM) value U(s, a) for each state and action pair can be set to 1 for the purpose of initialization. In some illustrative examples, [symbol] and [symbol] can be vectors of numerical values that present actions in action space [symbol] and states in state space [symbol] . In this illustrative example, action space [symbol] can also be set of vectors in which each vector includes actions that can be performed in a state.

The process determines whether the risk factor value a is greater than 0 (step 504). In this illustrative example, the risk factor value is a numerical value that indicates how much risk that is acceptable when making decisions on what action to take at each state. In step 504, the risk factor value a can be determined by user preference. In this illustrative example, α indicates risk-seeking decision-making when α is greater than 0 while α indicates risk-averse decision-making when α is less than 0.

In response to the risk factor value a being greater than 0, the process determines a change from the baseline value using a maximum probabilistic discounted entropic risk measure (p-ERM) value of all state and action pairs (step 506). In step 506, change from baseline b is a single value. In determining change from baseline b, a maximum value of normalized initial probabilistic discounted entropic risk measure (p-ERM) values of all actions at each state for all of the states is calculated as follows:

$$W ( s ) ← {max}_{a} U ( s , a ) , ∀ s ∈ \qquad ( 5 )$$

In this step, a maximum value of normalized initial probabilistic discounted entropic risk measure (p-ERM) is calculated for each state. With the values from Equation (5), the change from baseline b can be determined using following equation:

$$b ← {max}_{s , a , s ′} \{ r ( s , a , {s}^{′} ) + \frac{1}{α} log W ( {s}^{′} ) \} \qquad ( 6 )$$

where change from baseline b is determined by the maximum of

$$\{ r ( s , a , {s}^{′} ) + \frac{1}{α} log W ( {s}^{′} ) \}$$

for all state and action pairs, r(s, a, s′) is the immediate reward associated with transition from state s to state s′ by taking action a. In this example,

$$\frac{1}{α} logW ( {s}^{′} )$$

is the maximum normalized initial probabilistic discounted entropic risk measure (p-ERM) value of all actions at a state s′. U(s, a) is a normalized probabilistic discounted entropic risk measure (p-ERM) value at any given state and action pair in the state and actions pairs, W(s′) can be calculated by determining the maximum of function U(s′, a) as a varies for state s′ of state space S as described by Equation (5).

The process updates the normalized initial probabilistic discounted entropic risk measure (p-ERM) values for all state and action pairs using the change from baseline (step 508 ). In step 508, the normalized initial probabilistic discounted entropic risk measure (p-ERM) of all action and state pairs U(s, a) is updated using the following equation:

$$U ( s , a ) ← p ( {s}^{′} \vert s , a ) {e}^{α ( r ( s , a , {s}^{′} ) - b )} ( ( 1 - γ ) {e}^{- α B} + γW ( {s}^{′} ) ) , \qquad ( 7 )$$

$$∀ ( s , a ) ∈ \times$$

where state s′ can be transitioned from state s by taking action a, p(s′|s, a) is the transition probability from state s to state s′ when taking action a at state s, and r(s, a, s′) is the immediate reward associated with that transition, y is a discount rate, a is the risk factor determined in step 504, and W(s′) is the maximum transformed probabilistic discounted entropic risk measure (p-ERM) value at state s′. In this illustrative example, e^{α(r(s,a,s′)-b)} represents a transformed immediate reward of transitioning state s to state s′ by taking action a and ((1−γ)e^{-αB}+γW(s′)) represents a transformed p-ERM from state s′, and p(s′|s, a) is the probability of transitioning state s to state s′ by taking action a.

In this example ε can be added to the updated probabilistic discounted entropic risk measure (p-ERM) for all state and action pairs. As depicted, ε is a constant added to the updated U(s, a) to prevent arithmetic underflow.

The process updates the baseline B with the change from baseline b (step 510). In this illustrative example, baseline B can be updated by adding the existing baseline B with the change from baseline b determined in step 506. The process determines whether the updates to the normalized initial probabilistic discounted entropic risk measure (p-ERM) values are complete (step 512). In this illustrative example, the updates to the normalized initial probabilistic discounted entropic risk measure (p-ERM) value are complete when a predefined condition has been satisfied. In this step, the condition can be, for example, when a number of iterations has been performed or when the change of the normalized initial probabilistic discounted entropic risk measure values from its previous values is smaller than a predefined threshold. As described the values calculated are intermediate values that are used as the initial values for the next determination of values in this recursive process.

If the updates are not complete, the process returns to step 504 to repeat steps 504 to 512 using the updated baseline B obtained in step 510 as the initialized baseline and the updated U(s, a) obtained in step 508 as the normalized initial probabilistic discounted entropic risk measure (p-ERM) values for the new iteration until the predefined condition has been satisfied.

In this depicted example, the inclusion of baseline B in the calculation ensures that the updated probabilistic discounted entropic risk measure (p-ERM) values for all state and action pairs do not exceed 1. Here, because the normalized initial probabilistic discounted entropic risk measure (p-ERM) for all state and action pairs changes over iterations, the baseline B also needs to be updated in each iteration so that the normalized initial probabilistic discounted entropic risk measure (p-ERM) values for all state and action pairs do not exceed 1.

If the updates are complete, the process proceeds to compute final state and action value for all state and action pairs to change the normalized initial probabilistic discounted entropic risk measure (p-ERM) values to unnormalized values (step 514). The final probabilistic discounted entropic risk measure (p-ERM) can be expressed in a function of Q(s, a). In this illustrative example, Q(s, a) can be calculated for each action a taken at each state s as follows:

$$Q ( s , a ) ← \frac{1}{α} log U ( s , a ) + B , ∀ ( s , a ) ∈ \times \qquad ( 8 )$$

wherein the U(s, a) is the updated U(s, a) obtained in step 508; α is the risk factor value determined in step 504; and B is the updated baseline obtained in step 510. For each state and action pair, the value of the probabilistic discounted entropic risk measure is uniquely determined. This value represents the maximum cumulative reward that can be obtained from that state-action pair with risk being taken into account.

The process calculates the best risk-sensitive action for each state s of state space [symbol] (step 516). The process terminates thereafter. In step 516, the best risk-sensitive action for each state s can be calculated by using following equation:

π(s)=argmaxₐQ(s,a), ∀s∈ [symbol] (9)

In this illustrative example, the best risk-sensitive action for each state is determined by selecting the action that returns the maximum final probabilistic discounted entropic risk measure (p-ERM) value at each state.

With reference again to step 504, in response to the risk factor value a being less than 0, the process determines a change from baseline b using a minimum of probabilistic discounted entropic risk measure (p-ERM) value of all state and action pairs (step 518). In step 518, change from baseline b is a single value. In determining change from baseline b, a minimum value of normalized initial probabilistic discounted entropic risk measure (p-ERM) values of all actions at a state is calculated as follows:

$$W ( {s}^{′} ) ← {min}_{a} U ( {s}^{′} , a ) , ∀ s ∈ \qquad ( 10 )$$

In this step, a minimum normalized initial probabilistic discounted entropic risk measure (p-ERM) value is calculated for each state.

With the values from Equation (10), the change from baseline b can be determined using following equation:

$$b ← {min}_{s , a , {s}^{′}} \{ r ( s , a , {s}^{′} ) + \frac{1}{α} log W ( {s}^{′} ) \} \qquad ( 11 )$$

where change from baseline b is determined as the minimum of

$$\{ r ( s , a , {s}^{′} ) + \frac{1}{α} log W ( {s}^{′} ) \}$$

for all state and action pairs, r(s, a, s′) is the immediate reward associated with the transition from state s to state s′ by taking action a;

$$\frac{1}{α} log W ( {s}^{′} )$$

is the minimum normalized initial probabilistic discounted entropic risk measure (p-ERM) value of all actions at a state s′. U(s, a) is a probabilistic discounted entropic risk measure value at any given state and action pair in the state and actions pairs, W(s′) can be calculated by determining the minimum of function U(s′, a) as a varies for state s′ of state space [symbol] as described by Equation (10). The process proceeds to step 508 when a change from baseline b is obtained from step 518.

Turning next to FIG. 6, a flowchart of a process for determining a policy for risk sensitive decision-making is depicted in accordance with an illustrative embodiment. The process in FIG. 6 can be implemented in hardware, software, or both. When implemented in software, the process can take the form of program instructions that is run by one of more processor units located in one or more hardware devices in one or more computer systems. For example, the process can be implemented in policy manager 212 in computer system 210 in FIG. 2.

The process begins by receiving state and action pairs (step 600). The process determines with initial probabilistic discounted entropic risk measure values for the state and action pairs, in a recursive manner current probabilistic discounted entropic risk measure values for the state and action pairs based on a risk factor until the current probabilistic discounted entropic risk measure values reach a desired level (step 602). The current probabilistic discounted entropic risk measure values are the initial probabilistic discounted entropic risk measure values for a next determination in the recursive process.

The process selects a set of the state and action pairs for the policy using the current probabilistic discounted entropic risk measure values present in response to the probabilistic discounted entropic risk measure values reaching the desired level (step 604). The process terminates thereafter. A system can operate using the policy generated by this process.

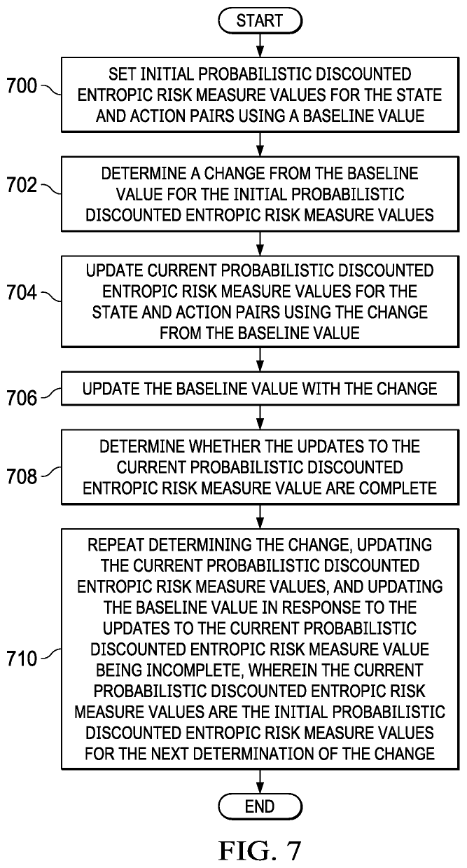

With reference to FIG. 7, a flowchart of a process for determining current probabilistic discounted entropic risk measure values for the state and action pairs based on a risk factor in a recursive manner is depicted in accordance with an illustrative embodiment. The process illustrated in FIG. 7 is an example of one implementation for step 602 in FIG. 6.

The process begins by setting initial probabilistic discounted entropic risk measure values for the state and action pairs using a baseline value (step 700). The process determines a change from the baseline value for the initial probabilistic discounted entropic risk measure values (step 702). In step 702, the manner in which the change from baseline value is determined depends on the amount of risk that can be tolerated. This amount of risk is a risk factor. For example, when the risk factor is greater than zero, the change from the baseline value for the initial probabilistic discounted entropic risk measure value is determined as follows:

$$W ( s ) ← {max}_{a} Q ( s , a ) , ∀ s ∈$$

$$b ← {max}_{s , a , {s}^{′}} \{ r ( s , a , {s}^{′} ) + \frac{1}{α} log W ( {s}^{′} ) \}$$

where s is a current state, a is an action, s′ is a next state, α is a risk factor, W(s) is a maximum probabilistic discounted entropic risk measure value, Q(s,a) is a probabilistic discounted entropic risk measure value at any given state and action pair in the state and actions pairs, and r(s, a, s′) is an immediate reward associated with a transition from the current state s to the next state s′.

When the risk factor is less than zero, the change from the baseline value for the initial probabilistic discounted entropic risk measure value is determined as follows:

$$W ( s ) ← {min}_{a} Q ( s , a ) , ∀ s ∈$$

$$b ← {min}_{s , a , {s}^{′}} \{ r ( s , a , {s}^{′} ) + \frac{1}{α} log W ( {s}^{′} ) \}$$

wherein s is a current state, a is an action, s′ is a next state, α is a risk factor, W(s) is a minimum probabilistic discounted entropic risk measure value, Q(s,a) is a probabilistic discounted entropic risk measure value at any given state and action pair in the state and actions pairs, and r(s, a, s′) is an immediate reward associated with a transition from the current state s to the next state s′.

The process updates current probabilistic discounted entropic risk measure values for the state and action pairs using the change from the baseline value (step 704). The process updates the baseline value with the change (step 706).

The process determines whether the updates to the current probabilistic discounted entropic risk measure value are complete (step 708). The process repeats determining the change, updating the current probabilistic discounted entropic risk measure values, and updating the baseline value in response to the updates to the current probabilistic discounted entropic risk measure value being incomplete, wherein the current probabilistic discounted entropic risk measure values are the initial probabilistic discounted entropic risk measure values for the next determination of the change (step 710). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

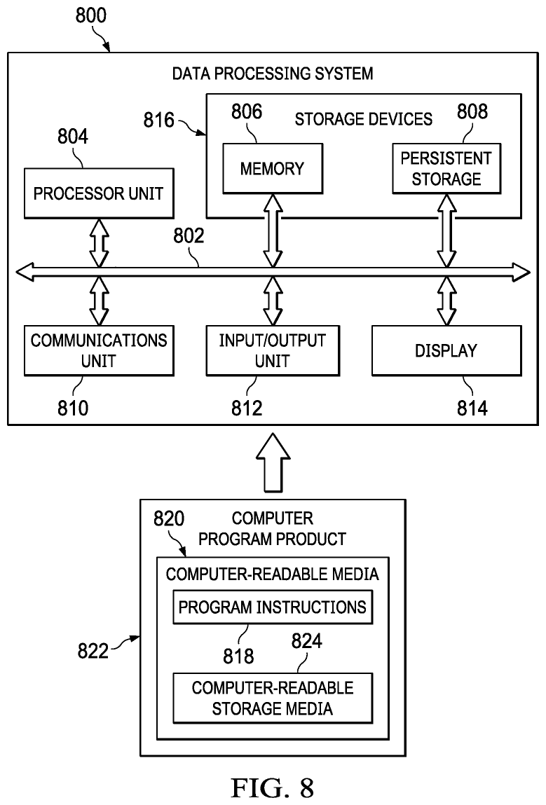

Turning now to FIG. 8, a block diagram of a data processing system is depicted in accordance with an illustrative embodiment. Data processing system 800 can be used to implement server computer 104, server computer 106, and client devices 110, in FIG. 1. Data processing system 800 can also be used to implement computer system 210. In this illustrative example, data processing system 800 includes communications framework 802, which provides communications between processor unit 804, memory 806, persistent storage 808, communications unit 810, input/output (I/O) unit 812, and display 814. In this example, communications framework 802 takes the form of a bus system.

Processor unit 804 serves to execute instructions for software that can be loaded into memory 806. Processor unit 804 includes one or more processors. For example, processor unit 804 can be selected from at least one of a multicore processor, a central processing unit (CPU), a graphics processing unit (GPU), a physics processing unit (PPU), a digital signal processor (DSP), a network processor, or some other suitable type of processor. Further, processor unit 804 can may be implemented using one or more heterogeneous processor systems in which a main processor is present with secondary processors on a single chip. As another illustrative example, processor unit 804 can be a symmetric multi-processor system containing multiple processors of the same type on a single chip.

Memory 806 and persistent storage 808 are examples of storage devices 816. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 816 may also be referred to as computer-readable storage devices in these illustrative examples. Memory 806, in these examples, can be, for example, a random-access memory or any other suitable volatile or non-volatile storage device. Persistent storage 808 may take various forms, depending on the particular implementation.

For example, persistent storage 808 may contain one or more components or devices. For example, persistent storage 808 can be a hard drive, a solid-state drive (SSD), a flash memory, a rewritable optical disk, a rewritable magnetic tape, or some combination of the above. The media used by persistent storage 808 also can be removable. For example, a removable hard drive can be used for persistent storage 808.

Communications unit 810, in these illustrative examples, provides for communications with other data processing systems or devices. In these illustrative examples, communications unit 810 is a network interface card.

Input/output unit 812 allows for input and output of data with other devices that can be connected to data processing system 800. For example, input/output unit 812 may provide a connection for user input through at least one of a keyboard, a mouse, or some other suitable input device. Further, input/output unit 812 may send output to a printer. Display 814 provides a mechanism to display information to a user.

Instructions for at least one of the operating system, applications, or programs can be located in storage devices 816, which are in communication with processor unit 804 through communications framework 802. The processes of the different embodiments can be performed by processor unit 804 using computer-implemented instructions, which may be located in a memory, such as memory 806.

These instructions are referred to as program instructions, computer usable program instructions, or computer-readable program instructions that can be read and executed by a processor in processor unit 804. The program instructions in the different embodiments can be embodied on different physical or computer-readable storage media, such as memory 806 or persistent storage 808.

Program instructions 818 is located in a functional form on computer-readable media 820 that is selectively removable and can be loaded onto or transferred to data processing system 800 for execution by processor unit 804. Program instructions 818 and computer-readable media 820 form computer program product 822 in these illustrative examples. In the illustrative example, computer-readable media 820 is computer-readable storage media 824.

Computer-readable storage media 824 is a physical or tangible storage device used to store program instructions 818 rather than a medium that propagates or transmits program instructions 818. Computer readable storage media 824, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 818 can be transferred to data processing system 800 using a computer-readable signal media. The computer-readable signal media are signals and can be, for example, a propagated data signal containing program instructions 818. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 820” can be singular or plural. For example, program instructions 818 can be located in computer-readable media 820 in the form of a single storage device or system. In another example, program instructions 818 can be located in computer-readable media 820 that is distributed in multiple data processing systems. In other words, some instructions in program instructions 818 can be located in one data processing system while other instructions in program instructions 818 can be located in one data processing system. For example, a portion of program instructions 818 can be located in computer-readable media 820 in a server computer while another portion of program instructions 818 can be located in computer-readable media 820 located in a set of client computers.

The different components illustrated for data processing system 800 are not meant to provide architectural limitations to the manner in which different embodiments can be implemented. In some illustrative examples, one or more of the components may be incorporated in or otherwise form a portion of, another component.

For example, memory 806, or portions thereof, may be incorporated in processor unit 804 in some illustrative examples. The different illustrative embodiments can be implemented in a data processing system including components in addition to or in place of those illustrated for data processing system 800. Other components shown in FIG. 8 can be varied from the illustrative examples shown. The different embodiments can be implemented using any hardware device or system capable of running program instructions 818.

Thus, illustrative embodiments provide a computer implemented method, computer system, and computer program product for determining a policy for risk sensitive decisions. A computer system receives state and action pairs. The computer system, with initial probabilistic discounted entropic risk measure values for the state and action pairs, determines in a recursive manner current probabilistic discounted entropic risk measure values for the state and action pairs based on a risk factor until the current probabilistic discounted entropic risk measure values reach a desired level. The current probabilistic discounted entropic risk measure values are the initial probabilistic discounted entropic risk measure values for a next determination. The computer system selects a set of the state and action pairs for the policy using the current probabilistic discounted entropic risk measure values present in response to the probabilistic discounted entropic risk measure values, wherein a system operates using the policy.

As a result, illustrative examples can determine policies for use in sequential decision-making that takes into account risk rather than maximizing the standard expected return.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for determining a policy for risk sensitive decision-making, the computer implemented method comprising:
receiving, by a computer system, state and action pairs;
determining, by the computer system with initial probabilistic discounted entropic risk measure values for the state and action pairs, in a recursive manner current probabilistic discounted entropic risk measure values for the state and action pairs based on a risk factor until the current probabilistic discounted entropic risk measure values reach a desired level, wherein the current probabilistic discounted entropic risk measure values are the initial probabilistic discounted entropic risk measure values for a next determination; and
selecting, by the computer system, a set of the state and action pairs for the policy using the current probabilistic discounted entropic risk measure values present in response to the current probabilistic discounted entropic risk measure values reaching the desired level, wherein a system operates using the policy.

2. The computer implemented method of claim 1, determining, by the computer system with the initial probabilistic discounted entropic risk measure values for the state and action pairs, in the recursive manner the current probabilistic discounted entropic risk measure values for the state and action pairs based on the risk factor comprises:
setting, by the computer system, the initial probabilistic discounted entropic risk measure values for the state and action pairs using a baseline value;
determining, by the computer system, a change from the baseline value for the initial probabilistic discounted entropic risk measure values;
updating, by the computer system, the current probabilistic discounted entropic risk measure values for the state and action pairs using the change from the baseline value;
updating, by the computer system, the baseline value with the change;
determining, by the computer system, whether to the updates to the current probabilistic discounted entropic risk measure values are complete; and
repeating, by the computer system, determining the change, updating the current probabilistic discounted entropic risk measure values, and updating the baseline value in response to the updates to the current probabilistic discounted entropic risk measure value being incomplete, wherein the current probabilistic discounted entropic risk measure values are the initial probabilistic discounted entropic risk measure values for the next determination of the change.

3. The computer implemented method of claim 2, wherein determining, by the computer system, the change from the baseline value for the initial probabilistic discounted entropic risk measure values comprises:
determining, by the computer system, the change from the baseline value for the initial probabilistic discounted entropic risk measure values using in response to a risk factor being greater than zero as follows:
$$W ( s ) ← {max}_{a} U ( s , a ) , ∀ s ∈$$
$$b ← {max}_{s , a , {s}^{′}} \{ r ( s , a , {s}^{′} ) + \frac{1}{α} log W ( {s}^{′} ) \}$$
wherein s is a current state, a is an action, s′ is a next state, α is the risk factor, W(s) is a maximum probabilistic discounted entropic risk measure value, Q(s,a) is a probabilistic discounted entropic risk measure value at any given state and action pair in the state and actions pairs, and r(s, a, s′) is an immediate reward associated with a transition from the current state s to the next state s′.

4. The computer implemented method of claim 2, wherein determining, by the computer system, the change from the baseline value for the initial probabilistic discounted entropic risk measure values comprises:
determining, by the computer system, the change from the baseline value for the initial probabilistic discounted entropic risk measure values using in response to a desired level being less than zero as follows:
$$W ( s ) ← {min}_{a} Q ( s , a ) , ∀ s ∈$$
$$b ← {min}_{s , a , {s}^{′}} \{ r ( s , a , {s}^{′} ) + \frac{1}{α} log W ( {s}^{′} ) \}$$
wherein s is a current state, a is an action, s′ is a next state, α is the risk factor, W(s) is a minimum probabilistic discounted entropic risk measure value, Q(s,a) is a probabilistic discounted entropic risk measure value at any given state and action pair in the state and actions pairs, and r(s, a, s′) is an immediate reward associated with a transition from the current state s to the next state s′.

5. The computer implemented method of claim 1, wherein states in the state and action pairs are sequential states.

6. The computer implemented method of claim 1 further comprising:
operating the system using the state and action pairs selected for the policy.

7. The computer implemented method of claim 1, wherein the system is one of a robot, a robotic arm, a self-driving vehicle, a manufacturing plant, a financial trading system, an inventory control system and a semiconductor wafer processing system.

8. A computer system comprising:
a number of processor units, wherein the number of processor units executes program instructions to:
receive state and action pairs;
determine, with initial probabilistic discounted entropic risk measure values for the state and action pairs, in a recursive manner current probabilistic discounted entropic risk measure values for the state and action pairs based on a risk factor until the current probabilistic discounted entropic risk measure values reach a desired level, wherein the current probabilistic discounted entropic risk measure values are the initial probabilistic discounted entropic risk measure values for a next determination; and
select a set of the state and action pairs for a policy using the current probabilistic discounted entropic risk measure values present in response to the current probabilistic discounted entropic risk measure values reaching the desired level, wherein a system operates using the policy.

9. The computer system of claim 8, in determining, with the initial probabilistic discounted entropic risk measure values for the state and action pairs, in the recursive manner the current probabilistic discounted entropic risk measure values for the state and action pairs based on the risk factor, the number of processor units executes program instructions to:
set the initial probabilistic discounted entropic risk measure values for the state and action pairs using a baseline value;
determine a change from the baseline value for the initial probabilistic discounted entropic risk measure values;
update the current probabilistic discounted entropic risk measure values for the state and action pairs using the change from the baseline value;
update the baseline value with the change;
determine whether to the updates to the current probabilistic discounted entropic risk measure value are complete; and
repeat determining the change, updating the current probabilistic discounted entropic risk measure values, and updating the baseline value in response to the updates to the current probabilistic discounted entropic risk measure value being incomplete, wherein the current probabilistic discounted entropic risk measure values are the initial probabilistic discounted entropic risk measure values for the next determination of the change.

10. The computer system of claim 9, wherein in determining, by the computer system, the change from the baseline value for the initial probabilistic discounted entropic risk measure values, the number of processor units executes program instructions to:
determine the change from the baseline value for the initial probabilistic discounted entropic risk measure values in response to a risk factor being greater than zero as follows:
$$W ( s ) ← {max}_{a} Q ( s , a ) , ∀ s ∈$$
$$b ← {max}_{s , a , {s}^{′}} \{ r ( s , a , {s}^{′} ) + \frac{1}{α} log W ( {s}^{′} ) \}$$
wherein s is a current state, a is an action, s′ is a next state, α is the risk factor, W(s) is a maximum probabilistic discounted entropic risk measure value, Q(s,a) is a probabilistic discounted entropic risk measure value at any given state and action pair in the state and actions pairs, and r(s, a, s′) is an immediate reward associated with a transition from the current state s to the next state s′.

11. The computer system of claim 9, wherein in determining, by the computer system, the change from the baseline value for the initial probabilistic discounted entropic risk measure values, the number of processor units executes program instructions to:
determine the change from the baseline value for the initial probabilistic discounted entropic risk measure value using as following in response to a risk factor being less than zero as follows:
$$W ( s ) ← {min}_{a} Q ( s , a ) , ∀ s ∈$$
$$b ← {min}_{s , a , {s}^{′}} \{ r ( s , a , {s}^{′} ) + \frac{1}{α} log W ( {s}^{′} ) \}$$
wherein s is a current state, a is an action, s′ is a next state, α is the risk factor, W(s) is a minimum probabilistic discounted entropic risk measure value, Q(s,a) is a probabilistic discounted entropic risk measure value at any given state and action pair in the state and actions pairs, and r(s, a, s′) is an immediate reward associated with a transition from the current state s to the next state s′.

12. The computer system of claim 8, wherein states in the state and action pairs are sequential states.

13. The computer system of claim 8, wherein the number of processor units executes program instructions to:
operate the system using the state and action pairs selected for the policy.

14. The computer system of claim 8, wherein the system is one of a robot, a robotic arm, a self-driving vehicle, a manufacturing plant, a financial trading system, an inventory control system and a semiconductor wafer processing system.

15. A computer program product for determining a policy for risk sensitive decision-making, the computer program product comprising a computer readable storage medium having program instructions embodied therewith, the program instructions executable by a computer system to cause the computer system to perform a method of:
receiving, by a computer system, state and action pairs;
determining, by the computer system with initial probabilistic discounted entropic risk measure values for the state and action pairs, in a recursive manner current probabilistic discounted entropic risk measure values for the state and action pairs based on a risk factor until the current probabilistic discounted entropic risk measure values reach a desired level, wherein the current probabilistic discounted entropic risk measure values are the initial probabilistic discounted entropic risk measure values for a next determination; and
selecting, by the computer system, a set of the state and action pairs for the policy using the current probabilistic discounted entropic risk measure values present in response to the current probabilistic discounted entropic risk measure values reaching the desired level, wherein a system operates using the policy.

16. The computer program product of claim 15, wherein determining, by the computer system with the initial probabilistic discounted entropic risk measure values for the state and action pairs, in the recursive manner the current probabilistic discounted entropic risk measure values for the state and action pairs based on the risk factor comprises:
setting, by the computer system, the initial probabilistic discounted entropic risk measure values for the state and action pairs using a baseline value;
determining, by the computer system, a change from the baseline value for the initial probabilistic discounted entropic risk measure values;
updating, by the computer system, the current probabilistic discounted entropic risk measure values for the state and action pairs using the change from the baseline value;
updating, by the computer system, the baseline value with the change;
determining, by the computer system, whether to the updates to the current probabilistic discounted entropic risk measure value are complete; and
repeating, by the computer system, determining the change, updating the current probabilistic discounted entropic risk measure values, and updating the baseline value in response to the updates to the current probabilistic discounted entropic risk measure value being incomplete, wherein the current probabilistic discounted entropic risk measure values are the initial probabilistic discounted entropic risk measure values for the next determination of the change.

17. The computer program product of claim 16, wherein determining, by the computer system, the change from the baseline value for the initial probabilistic discounted entropic risk measure values comprises:
determining, by the computer system, the change from the baseline value for the initial probabilistic discounted entropic risk measure value using as following in response to a risk factor being greater than zero as follows:
$$W ( s ) ← {max}_{a} Q ( s , a ) , ∀ s ∈$$
$$b ← {max}_{s , a , {s}^{′}} \{ r ( s , a , {s}^{′} ) + \frac{1}{α} log W ( {s}^{′} ) \}$$
wherein s is a current state, a is an action, s′ is a next state, α is risk factor, W(s) is a maximum probabilistic discounted entropic risk measure value, Q(s,a) is a probabilistic discounted entropic risk measure value at any given state and action pair in the state and actions pairs, and r(s, a, s′) is an immediate reward associated with a transition from the current state s to the next state s′.

18. The computer program product of claim 16, wherein determining, by the computer system, the change from the baseline value for the initial probabilistic discounted entropic risk measure values comprises:
determining, by the computer system, the change from the baseline value for the initial probabilistic discounted entropic risk measure value using as following in response to as follows:
$$W ( s ) ← {min}_{a} Q ( s , a ) , ∀ s ∈$$
$$b ← {min}_{s , a , {s}^{′}} \{ r ( s , a , {s}^{′} ) + \frac{1}{α} log W ( {s}^{′} ) \}$$
wherein s is a current state, a is an action, s′ is a next state, α is risk factor, W(s) is a minimum probabilistic discounted entropic risk measure value, Q(s,a) is a probabilistic discounted entropic risk measure value at any given state and action pair in the state and actions pairs, and r(s, a, s′) is an immediate reward associated with a transition from the current state s to the next state s′.

19. The computer program product of claim 15, wherein states in the state and action pairs are sequential states.

20. The computer program product of claim 15 further comprising:
operating the system using the state and action pairs selected for the policy.
